(19) United States
(12) Patent Application Publication
(10) Pub. No.: US 2016/0359244 A1
(43) Pub. Date: Dec. 8, 2016

(54) TERMINAL, CONNECTION STRUCTURAL BODY, AND METHOD OF MANUFACTURING TERMINAL

(71) Applicants: FURUKAWA ELECTRIC CO., LTD., Tokyo (JP); FURUKAWA AUTOMOTIVE SYSTEMS INC., Shiga (JP)

(72) Inventor: Akira TACHIBANA, Tokyo (JP)

(73) Assignees: FURUKAWA ELECTRIC CO., LTD., Tokyo (JP); FURUKAWA AUTOMOTIVE SYSTEMS INC., Shiga (JP)

(21) Appl. No.: 14/913,850

(22) PCT Filed: Sep. 12, 2014
(86) PCT No.: PCT/JP2014/074218

§ 371 Date: Feb. 23, 2016

(30) Foreign Application Priority Data
Sep. 12, 2013 (JP) 2013-189054

(51) Int. Cl. H01R 4/62; H01R 13/03; H01R 43/20; H01R 13/11; H01R 43/04; H01R 4/18; H01R 13/04

(52) U.S. Cl. CPC H01R 4/62; H01R 4/185; H01R 13/035; H01R 13/04; H01R 13/113; H01R 4/18; H01R 43/04; H01R 43/20; H01R 2201/26

(57) ABSTRACT

A terminal and connection structural body that can restrain galvanic corrosion occurring between a core wire of a covered electrical wire and a terminal formed of different types of metal, and that can ensure conductive function. The terminal includes a box part as a connection part connected to another terminal and a wire barrel part as a crimping part crimp-connected to a covered electrical wire. All of a non-contact part, including an end surface as a cut surface upon blanking a metal member, is covered with a resin covered part, where the non-contact part is other than a contact part with another terminal, a non-covered part, and a contact part with an end part as an exposed part of a core wire of a covered electrical wire, a non-covered part.

### TECHNICAL FIELD

The present invention relates to a terminal used, for example, for a wire harness for an automobile, a connection structural body thereof, and a method of manufacturing a terminal.

### BACKGROUND ART

When a covered electrical wire and a terminal in a wire harness for an automobile or the like are connected, a crimp-connection is generally used in which an electrical wire is crimped and swaged by a so-called open-barrel type terminal. However, in a connection structural body with an electrical wire using an open-barrel type terminal, when water or the like adheres to a connection portion (contact point) between an electrical wire and a terminal, oxidation on a metal surface used for an electrical wire and a terminal base material progresses, resulting in an increase in electric resistance in the connection portion. Further, when an electrical wire and a terminal use a different metal, corrosion between different types of metal progresses. Progression of oxidation or corrosion of metal in the connection portion results in a breakage or a connection failure in the connection portion, which possibly affects a product longevity. In particular, in recent years, a wire harness is put to practical use where an aluminum alloy is used as an electrical wire and a copper alloy is used as a terminal base material, so that a problem of oxidation and corrosion in a connection portion becomes significant.

To prevent oxidation and corrosion in such a connection structural body, there has been proposed a structure where a terminal made of copper or a copper alloy is crimped and joined to an electrical wire having a conductor made of an aluminum alloy and in a terminal, most of a non-contact region other than a contact section with a conductor and a contact section with an external terminal is covered with an insulating cover (Patent Literature 1). Further, there has been proposed a technology where a terminal main body is configured of an aluminum material and a resilient lug that supports a terminal contact point in contact with an electrically connected connection terminal is configured of an iron-based material (see Patent Literature 2). Further, as another galvanic corrosion prevention structure of an aluminum electrical wire, there has been proposed a structure where a core wire exposed from a terminal portion of an electrical wire is covered with an intermediate cap to establish a conduction connection between the core wire and the intermediate cap, and a conduction connection is established between the intermediate cap and a terminal metal tool, whereby a conduction connection is established between the electrical wire and the terminal metal tool (see Patent Literature 3).

### CITATION LIST

### Patent Literature

[PTL 1] Japanese Patent Application Publication No. 2010-257719

[PTL 2] Japanese Patent Application Publication No. 2004-199934

[PTL 3] Japanese Patent Application Publication No. 2004-207172

### SUMMARY OF INVENTION

### Technical Problem

However, in the structure proposed in Patent Literature 1, an insulating cover is not provided on a cut end surface formed when a base material is blanked before a terminal is applied to bending, and thus, a galvanic corrosion may tend to occur from the cut end surface due to water adhesion.

Further, it is difficult to introduce the structure proposed in Patent Literature 2 to a conventional terminal processing that has been performed inconsistent continuous processing where a base material is blanked into a predetermined shape by pressing and then applied to bending, and thus, mass production is difficult. Further, there is a problem that a galvanic corrosion occurs between a material configuring a resilient lug and aluminum configuring a terminal main body.

Moreover, the structure proposed in Patent Literature 3 has a problem that an electrical wire crimp-connection structure is complicated, and it is thus difficult to optimize a crimp-connection condition, that is, a swaging connection, and further, in the above configuration, in addition, when a very small gap or the like occur, a galvanic corrosion rapidly progresses and it is thus difficult to maintain a conductive function.

The present invention has been made in view of the above-mentioned circumstances, and it is an object of the present invention to provide a terminal and a connection structural body with which it is possible to excellently restrain a galvanic corrosion (bimetallic corrosion) that occurs between a core wire of a covered electrical wire and a terminal which are formed of different types of metal and further ensure a conductive function.

### Solution to Problem

The specification contains an entire content of Japanese Patent Application No. 2013-189054 applied on Sep. 12, 2013.

A terminal of the present invention is a terminal having a connection part connected to another terminal and a crimping part crimp-connected to a covered electrical wire, wherein substantially all of a non-contact part, including a cut end surface upon blanking a metal member, is covered with a resin covered part, where the non-contact part is other than the contact part with the other terminal and the contact part with an exposed part of a conductor of the covered electrical wire.

Substantially all of a non-contact part is covered with a resin covered part, where the non-contact part is other than a contact part with another terminal and a contact part with an exposed part of a conductor of a covered electrical wire, thereby it is possible to excellently restrain a galvanic corrosion that occurs between a core wire of a covered electrical wire and a terminal which are formed of different types of metal.

According to the above configuration, substantially all of the above-described non-contact part, particularly including a cut end surface upon blanking a metal member, is covered with a resin covered part, and thus, corrosion current hardly flows between a conductor of a covered electrical wire and a terminal even though water adheres to a surface of the conductor of the covered electrical wire and the terminal when crimping the conductor of the covered electrical wire to a crimping part. Therefore, it is possible to excellently restrain a galvanic corrosion and to ensure a conductive function between a conductor of a covered electrical wire and a terminal over a long period.

In the above configuration, the crimping part may be configured by a wire barrel part and an insulation barrel part. According to this configuration, the wire barrel part is capable of securing the contact part with the exposed part of the conductor of the covered electrical wire, and when a resin covered part is provided to the insulation barrel part, the insulation barrel part is capable of increasing an area of the resin covered part of a terminal while securing conduction between a terminal and a conductor of a covered electrical wire.

Further, in the above configuration, the resin covered part may be formed by a pulse spray method.

A pulse spray method is a technique to coat resin fluid by spraying while switching on and off at a constant pulse interval. The pulse interval is extremely short, and by not continuously applying force (pressure) to the fluid, it is possible to spray the fluid with low viscosity. This decreases problems such as fluid clogging or liquid balling. As a result, it is possible to turn resin fluid into a suitable mist state and thereby it is possible to coat an object having a complicated shape with the resin fluid. That is, it is possible to easily and uniformly cover even a cut end surface (end surface) upon blanking of a terminal, with resin. It is noted that an adjustment is made appropriately for a spraying pulse period, jetting direction, the number of jet outlets, etc. in accordance with a purpose. As described above, forming a resin covered part with the pulse spray method enables resin cover to be uniformly formed even when including a cut end surface (end surface) within a covering range of a terminal, and thus, it is possible to excellently restrain a galvanic corrosion.

Further, in the above configuration, the resin covered part is preferably formed to cover equal to or more than 95% of a terminal surface.

Further, a connection structural body of the present invention may connect a covered electrical wire to a crimping part of the terminal. According to this configuration, corrosion current hardly flows between a conductor of a covered electrical wire and a terminal even though water adheres to a surface of the conductor of the covered electrical wire and the terminal. Therefore, it is possible to excellently restrain a galvanic corrosion and to ensure a conductive function between a conductor of a covered electrical wire and a terminal over a long period.

Further, a method of manufacturing a terminal of the present invention is a method of manufacturing a terminal having a connection part connected to another terminal and a crimping part crimp-connected to a covered electrical wire, wherein substantially all of a non-contact part, including a cut end surface upon blanking a metal member, is covered with resin, where the non-contact part is other than a contact part with the other terminal and a contact part with an exposed part of a conductor of the covered electrical wire.

Further, in the above configuration, a step of being covered with resin may be coating resin fluid by spraying at a constant interval.

Further, in the above configuration, a step of being covered with resin may be performed while the contact part is being masked prior to being covered with resin. According to this configuration, it is possible to secure the contact part by masking.

### Advantageous Effects of Invention

In the present invention, all of a non-contact part, including a cut end surface upon blanking a metal member, is covered with a resin covered part, and thus, it is possible to make corrosion current hard to flow between an exposed part of a conductor of a covered electrical wire and a terminal. Therefore, it is possible to excellently restrain a galvanic corrosion and to ensure a conductive function between a conductor of a covered electrical wire and a terminal over a long period.

### BRIEF DESCRIPTION OF DRAWINGS

FIG. 1 is a perspective view showing a terminal and a covered electrical wire that configure a connection structural body of a first embodiment of the present invention. FIG. 1(A) is a perspective view showing a terminal that is cut off at a widthwise center before crimping the covered electrical wire, FIG. 1(B) is a perspective view showing the terminal and the covered electrical wire before crimping the wire, and FIG. 1(C) is a perspective view showing the connection structural body.

FIG. 2 is an explanatory drawing showing a procedure of forming a chain terminal.

FIG. 3 is an explanatory drawing showing a resin covered part of a terminal material that is formed on the chain terminal. FIG. 3(A) is a plan view showing one side of a surface of the chain terminal that is blanked from a metal member, and FIG. 3(B) is a plan view showing the other side of the surface of the chain terminal that is blanked from the metal member.

FIG. 4 is a part plan view showing an end surface resin covered part and a chamfered resin covered part at the terminal material formed in the chain terminal.

FIG. 5 is a plan view showing an inner side resin covered part of a second embodiment.

FIG. 6 is a perspective view showing a male terminal of the second embodiment of the present invention.

FIG. 7 is a schematic diagram showing a contact surface with a terminal of a tab. FIG. 7(A) is a diagram showing a first contact surface of the tab, and FIG. 7(B) is a diagram showing a second contact surface of the tab.

### DESCRIPTION OF EMBODIMENTS

One embodiment of the present invention is described hereinafter by reference to the drawings.

### First Embodiment

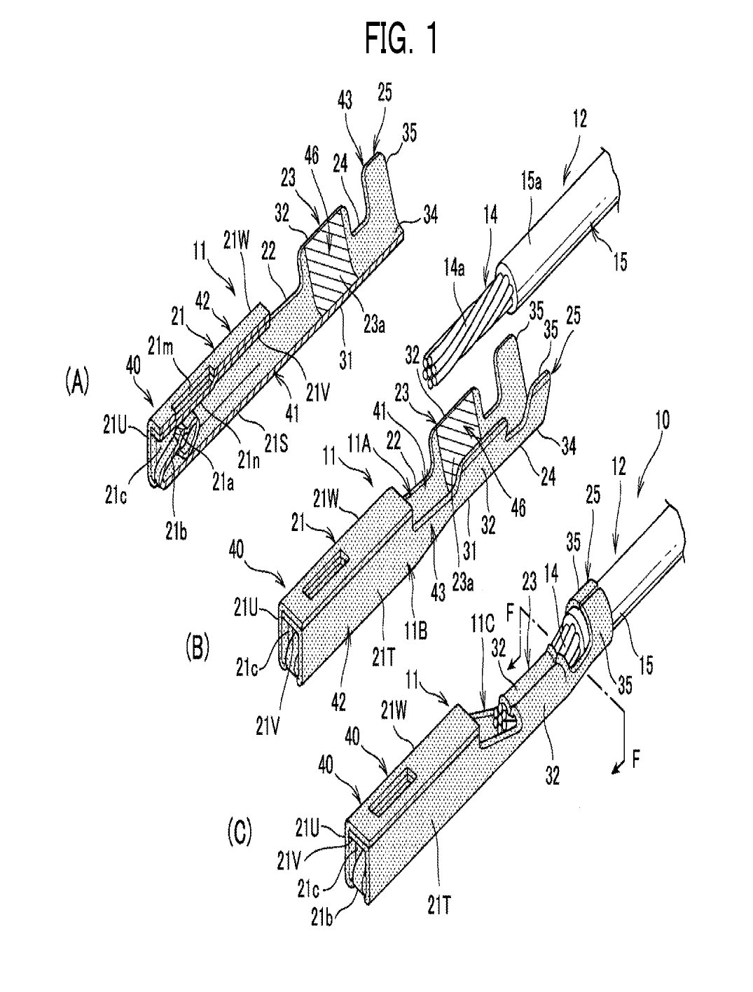

FIG. 1 is a perspective view showing a terminal 11 and a covered electrical wire 12 that configure a connection structural body 10 of a first embodiment of the present invention. FIG. 1(A) is a perspective view showing the terminal 11 that is cut off at a widthwise center before crimping the covered electrical wire, FIG. 1(B) is a perspective view showing the terminal 11 and the covered electrical wire 12 before crimping the wire, and FIG. 1(C) is a perspective view showing the connection structural body 10.

As shown in FIG. 1(A) and FIG. 1(B), the terminal 11 is, for example, a female terminal, and integrally includes a box part 21, a first transition part 22, a wire barrel part 23, a second transition part 24, and an insulation barrel part 25 in the order from one end side of a longitudinal direction.

The terminal 11 is formed by blanking a metal member and applying to bend processing (press processing).

A metal member consists of a base material of a metal material (for example, copper, aluminum, iron, or an alloy containing them as a main component or the like) and a plated part that is arbitrarily provided on a surface of the metal material. The plated part may be provided on a part or the entire of a metal base material, and is preferably noble metal plating such as tin (Sn) plating or silver (Ag) plating. Further, as ground plating, a plating layer made of nickel (Ni), cobalt (Co), or an alloy containing them as a main component or the like may be provided on the plated part. The plated part usually has a width of 0.1 to 1.2 μm.

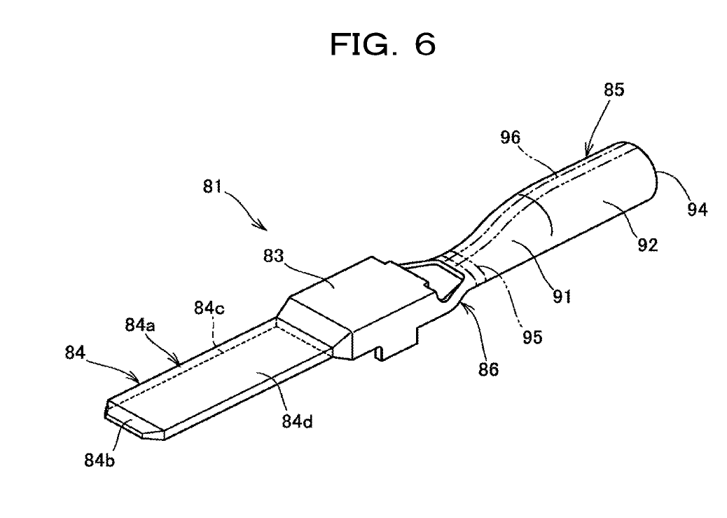

The box part 21 is bent to be formed in a box shape, and is a part at which a male terminal 81 (see FIG. 6) is allowed to be inserted. Inside the box part 21, a contact lug 21b having a contact projecting part 21a, which is bent and contacts with an insertion tab of the male terminal, is integrally included. It is noted that reference numeral 21m is an opening of a rectangle formed at an upper part of the box part 21, and 21n is a lower projecting part press-formed through the opening 21m.

The first transition part 22 has a predetermined length and is a part connecting the box part 21 with the wire barrel part 23.

The wire barrel part 23 is a part at which a core wire 14, a conductor of the covered electrical wire 12, is swaged and crimpled. The wire barrel part 23 before crimping is configured by a barrel base part 31 and wire barrel lugs 32, 32 extending obliquely outside upward from both sides of the widthwise direction of the barrel base part 31, and swages the core wire 14 at the wire barrel lugs 32, 32 to be mechanically and electrically connected. The barrel base part 31 and the wire barrel lugs 32, 32 are formed in approximately U-shape when viewed from an end part in the longitudinal direction.

The second transition part 24 has a predetermined length and is a part connecting the wire barrel part 23 with the insulation barrel part 25.

The insulation barrel part 25 is a part at which an insulating cover 15 of the covered electrical wire 12 is swaged and fixed. The insulation barrel part 25 before crimping is configured by a barrel base part 34 and insulation barrel lugs 35, 35 extending obliquely outside upward from both sides of the widthwise direction of the barrel base part 34, and swages the insulating cover 15 at the insulation barrel lugs 35, 35 to be mechanically connected. The barrel base part 34 and the insulation barrel lugs 35, 35 are formed in approximately U-shape when viewed from the end part in the longitudinal direction.

The covered electrical wire 12 is configured of the core wire 14 consisting of a twisted wire formed by twisting copper, aluminum, or element wires of an alloy containing them as a main component, and the insulating cover 15 made of an insulation resin that covers the core wire 14. The core wire 14 is a conductor of the covered electrical wire 12. The core wire 14 has a cross section (electrical wire size) of 0.75 mm² to 3 mm², and has 11 to 37 element wires. In FIG. 1(B), an end part of the insulating cover 15 of the covered electrical wire 12 is peeled off by a predetermined length and an end part (exposed part) 14a is exposed. The end part 14a is crimp-connected to the wire barrel part 23 of the terminal 11. Further, an end part 15a of the insulating cover 15 is connected to the insulation barrel part 25 of the terminal 11.

Here, in the terminal 11, the core wire 14 of the covered electrical wire 12 and a portion not contacting the male terminal at all are referred to as a non-contact part, but the non-contact part may include a portion contacting with a part of the core wire 14 of the covered electrical wire 12 and a part of the male terminal. In the present embodiment, substantially all of the surface of the above-mentioned non-contact part, including a cut end surface upon blanking a metal member, is covered with a resin covered part 40 whose surface is made of insulation resin (that is, a portion drawn by dots). Here, “substantially all” means 95% or more of the surface area of the terminal, and preferably 99% or more.

Such terminal 11 and covered electrical wire 12 configure the connection structural body 10. More specifically, as shown in FIG. 1(C), with a terminal crimping machine (not shown), the connection structural body 10 is formed by crimping the wire barrel lugs 32, 32 of the wire barrel part 23 to the core wire 14 of the covered electrical wire 12 and the insulation barrel lugs 35, 35 of the insulation barrel part 25 to the insulating cover 15 of the covered electrical wire 12.

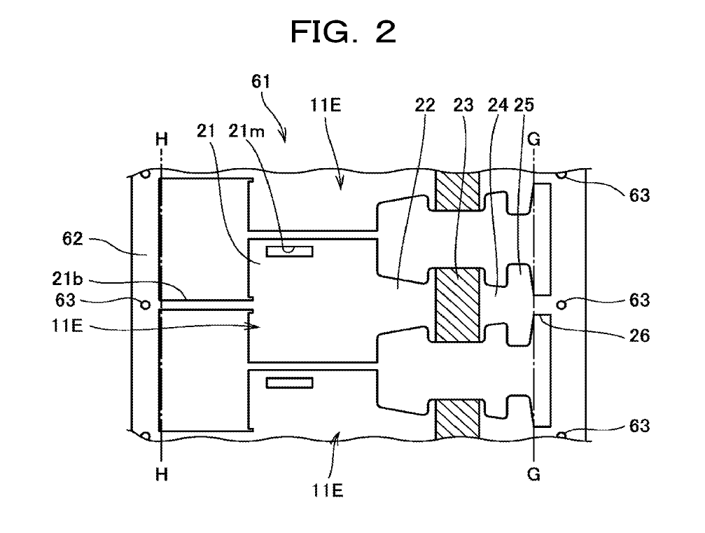

Next, a method of manufacturing the above-mentioned terminal 11, specifically from blanking to formation of the resin covered part, will be described. FIG. 2 is an explanatory drawing showing a procedure of forming a chain terminal 61.

Firstly, a metal member which is formed by tin-plating at least a portion of a base material, for example, that is made of a copper alloy and that has a plate thickness of 0.25 mm so that the plated portion is formed as a plated part is blanked by a press machine etc. so that a plurality of flat-plate-shaped terminal materials 11E and a frame part 62 coupling these terminal materials 11E are formed therein.

In this pressing step, one end of each terminal material 11E is respectively separated (half-blanked) from the frame part 62 at line H-H shown in the drawing to form the chain terminal 61 with the other end of the terminal material 11E coupled thereto. It is noted that reference numeral 63 shown in the drawing is a pilot hole opened for detecting a longitudinal position of the chain terminal 61. For names of each part of the terminal material 11E, the same names of each part of the terminal 11 before bend processing is applied (see FIG. 1(B)) are used.

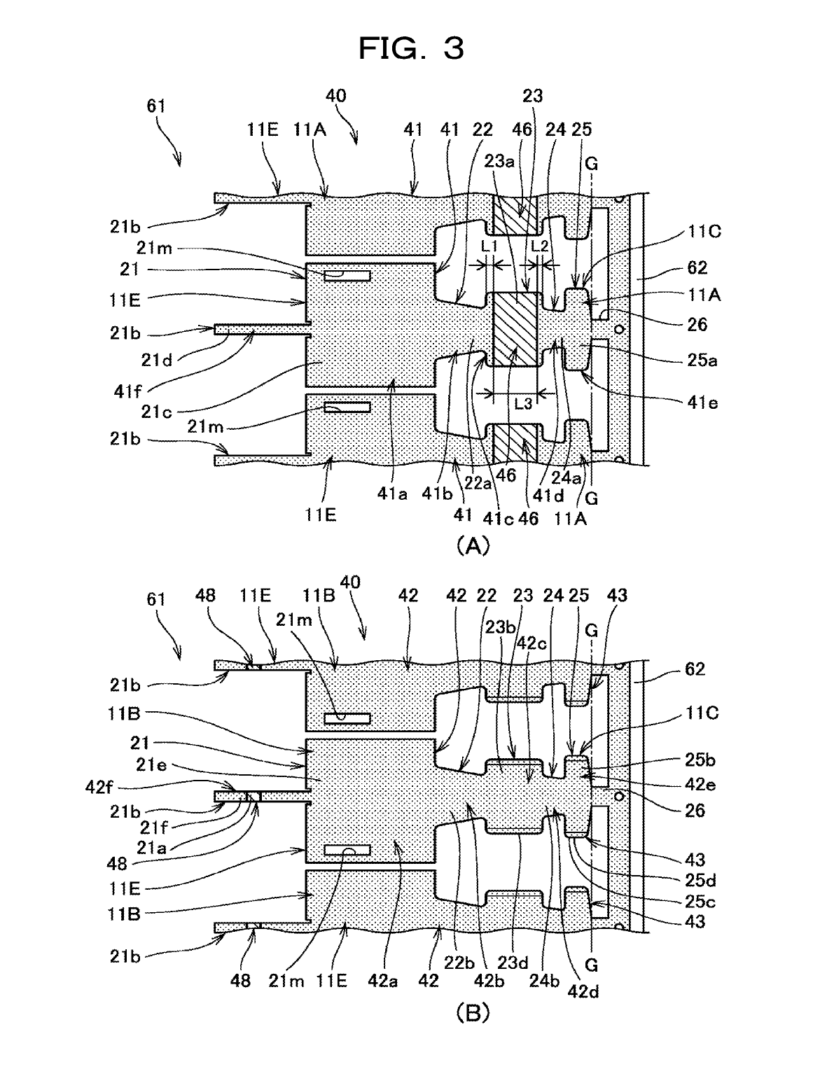

FIG. 3 is an explanatory drawing showing a resin covered part 40 of a terminal material 11E that is formed on the chain terminal 61. FIG. 3(A) is a plan view showing one side of a surface of the chain terminal 61 that is blanked from a metal member, and FIG. 3(B) is a plan view showing the other side of the surface of the chain terminal 61 that is blanked from the metal member.

The one side of the surface of the chain terminal 61 is a surface on an inner surface 11A side of the terminal 11 shown in FIG. 1(B). Further, the other side of the surface of the chain terminal 61 is a surface on an outer surface 11B side of the terminal 11 shown in FIG. 1(B).

On the non-contact part of the one side and the other side of the chain terminal 61, the resin covered part 40 is formed respectively, as shown with dots.

Next, a manner of forming the above-mentioned resin covered part 40.

Firstly, in FIG. 3(A) and FIG. 3(B), each step of electrolytic degreasing, pickling treatment, water washing, and drying is performed in this order, on the chain terminal 61.

Secondly, an ultraviolet-curable resin (acrylate resin, 3052C produced by ThreeBond Co., Ltd.) is applied to the inner surface 11A, outer surface 11B, and an end surface 11C of each terminal material 11E as well as chamfered parts 23d, 25d such that a coating thickness has a cover thickness t=10 μm (±1μm), then a predetermined ultraviolet ray irradiation is performed, and further the resin is crosslinked and cured, to form an inner side resin covered part 41, an outer side resin covered part 42, an end surface resin covered part 43, and a chamfered resin covered part 44 on the inner surface 11A, outer surface 11B, and end surface 11C of terminal material 11E as well as chamfered parts 23d, 25d respectively.

Further, as another method of forming the resin covered part 40, after each step of electrolytic degreasing, pickling treatment, water washing, and drying is performed on the chain terminal 61, a polyamideimide (PAI) solution varnish (at a solid content of about 30%) using N-methyl-2-pyrrolidone as solvent is applied to a predetermined section of the terminal material 11E and the inner surface 11A, outer surface 11B, end surface 11C of each terminal material 11E as well as the chamfered parts 23d, 25d with the coating thickness such that the cover thickness t is 10 μm (±1 μm) after baking. Then, a predetermined heating treatment is performed, the resin is cured along with solvent drying, to form each resin covered part 41 to 44.

It is noted that a pulse spray method is a method of coating a resin by spraying resin fluid (varnish etc.) in a mist state.

Conventionally, industrial coating of the resin fluid is performed by allowing the resin fluid to flow from one direction. For example, a roll coater is typical. With such a method, it is easy to coat an object having a plate shape; however, it is impossible to coat an object having a complicated shape or an object having a three-dimensional shape. Therefore, coating the resin by spraying may be considered, but most of the resin fluid used for industrial uses have high viscosity, and thus, the resin is clogged at jet outlets of spray and becomes liquid balls without becoming mist when applying a coating with a normal spray. Further, a resin having excellent heat resistance, hardness, etc. tends to have higher viscosity when adjusting a resin content in the varnish in consideration of baking. Accordingly, it is technically difficult to form a resin coating by coating, especially, a high-functioned resin (for example, polyimide) by spraying.

In the present embodiment, by using the pulse spray method, it becomes possible to form a three-dimensional resin covered part 40 on the terminal.

The pulse spray method is a technique to coat resin fluid by spraying while switching on and off at a constant pulse interval. The pulse interval is extremely short, and by not continuously applying force (pressure) to the fluid, it is possible to spray with low viscosity. This decreases problems such as fluid clogging or liquid balling. As a result, it is possible to turn resin fluid into a suitable mist state and thereby it is possible to coat an object having a complicated shape with the resin fluid. That is, it is possible to easily and uniformly cover even a blanked surface (end surface) of a terminal, with resin. It is noted that an adjustment is made appropriately for a spraying pulse period, jetting direction, the number of jet outlets, etc. in accordance with a purpose.

Spraying a resin fluid by using the pulse spray method is performed on at least the one side of the chain terminal 61 and performed simultaneously on both surfaces of the one side and the other side of the chain terminal 61 to form the resin covered part 40 simultaneously on the inner surface 11A, outer surface 11B, and end surface 11C of the terminal material 11E as well as chamfered parts 23, 25d.

At a point when a metal member is blanked by a press machine etc., the blanked surface does not have a plated part. Therefore, a plated part may be formed on the terminal separately, if it is needed.

In FIG. 3(A), the inner surface 11A of each terminal material 11E has an inner surface 21c of the box part 21, an inner surface 21d of the contact lug 21b, an inner surface 22a of the first transition part 22, an inner surface 23a of the wire barrel part 23, an inner surface 24a of the second transition part 24, and an inner surface 25a of the insulation barrel part 25. The inner side resin covered part 41 is provided on the inner surface 11A except a part of an outer surface 23a of the wire barrel part 23.

The inner side resin covered part 41 is configured of a first inner surface covered part 41a provided on the inner surface 21c of the box part 21, a second inner surface covered part 41b provided on the inner surface 22a of the first transition part 22, a third inner surface covered part 41c provided on the inner surface 23a of the wire barrel part 23, a forth inner surface covered part 41d provided on the inner surface 24a of the second transition part 24, a fifth inner surface covered part 41e provided on the inner surface 25a of the insulation barrel part 25, and a sixth inner surface covered part 41f provided on the inner surface 21d of the contact lug 21b.

The third inner surface covered part 41c is formed only within a range of a distance L1 from one end of the wire barrel part 23 and a distance L2 from the other end, and not formed within a longitudinal length L3 of the terminal material 11E. The inner surface 23a of the wire barrel part 23 on which the resin cover is not provided is a non-covered part 46 contacting the core wire 14 (see FIG. 1(B)) of the covered electrical wire 12 (see FIG. 1(B)).

A width L3 of the non-covered part 46 is a width contacting the end part (exposed part) 14a (see FIG. 1(B)) of the core wire 14, and is formed shorter than the end part 14a.

In FIG. 3(B), the outer surface 11B of each terminal material 11E has an outer surface 21e of the box part 21, an outer surface 21f of the contact lug 21b, an outer surface 22b of the first transition part 22, an outer surface 23b of the wire barrel part 23, an outer surface 24b of the second transition part 24, and an outer surface 25b of the insulation part 25. The outer side resin covered part 42 is provided on the outer surface 11B except a part of the outer surface 21f of the contact lug 21b.

The outer side resin covered part 42 is configured of a first outer side covered part 42a provided on the outer surface 21e of the box part 21, a second outer surface covered part 42b provided on the outer surface 22b of the first transition part 22, a third outer surface covered part 42c provided on the outer surface 23b of the wire barrel part 23, a forth outer surface covered part 42d provided on the outer surface 24b of the second transition part 24, a fifth outer surface covered part 42e provided on the outer surface 25b of the insulation barrel part 25, and a sixth outer surface covered part 41f provided on a portion of the outer surface 42f of the contact lug 21b except the contact projecting part 21a.

On the contact projecting part 21a, the resin covered part 40 is not formed but a non-covered part 48 contacting a male terminal is provided.

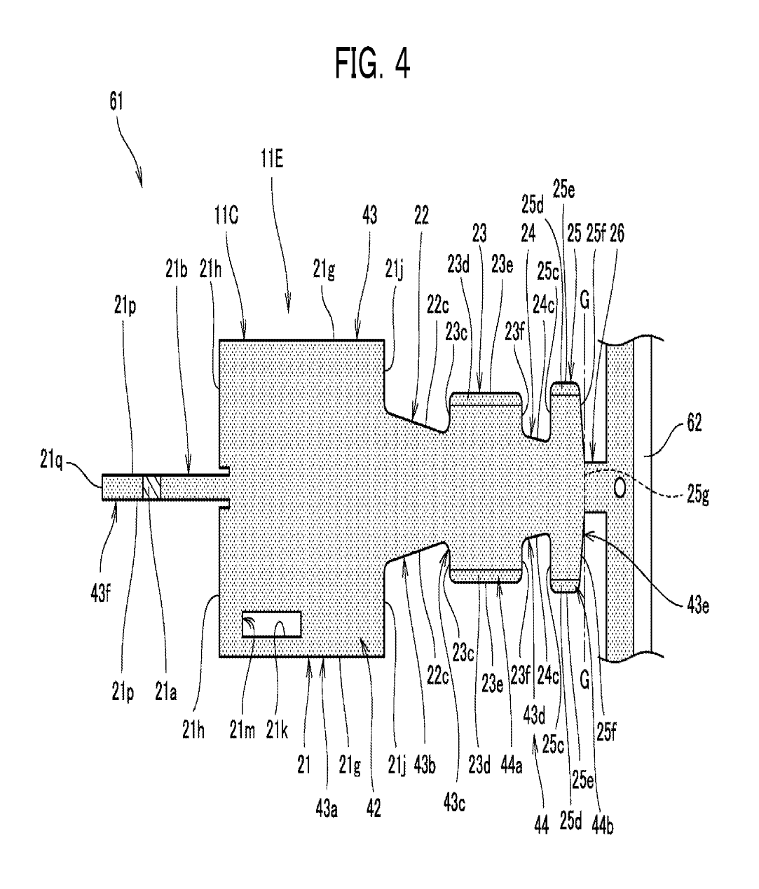

FIG. 4 is a part plan view showing an end surface resin covered part 43 and a chamfered resin covered part 44 at the terminal material 11E formed in the chain terminal 61.

When the inner side resin covered part 41 (see FIG. 3(A)) and the outer side resin covered part 42 are formed on the terminal material 11E, an end surface resin covered part 43 and a chamfered resin covered part 44 are also formed at the same time.

The terminal material 11E has: end surfaces 21g, 21g extending in the longitudinal direction of the box part 21, end surfaces 21h, 21h, 21j, 21j extending in the widthwise direction of the box part 21, and an end surface 21k of the opening 21m; end surfaces 22c, 22c of the first transition part 22; end surfaces 23c, 23c, 23e, 23e, 23f, 23f of the wire barrel part 23; end surfaces 24c, 24c of the second transition part 24; end surfaces 25c, 25c, 25e, 25e, 25f, 25f of the insulation barrel 25; an end surface 25g which is formed at the insulation barrel part 25 when the terminal material 11E is separated from an end part protruding part 26 provided on the frame part 62 of the chain terminal 61; end surfaces 21p, 21p of the contact lug 21b; and an end surface 21q which is formed at a tip of the contact lug 21b when the terminal material 11E is separated from the frame part 62 of the chain terminal 61.

The end surface resin covered part 43 is configured of a first end surface covered part 43a provided on end surfaces 21g, 21g, 21h, 21h, 21j, 21j, 21k of the box part 21, a second end surface covered part 43b provided on the end surfaces 22c, 22c of the first transition part 22, a third end surface covered part 43c provided on the end surfaces 23c, 23c, 23e, 23e, 23f, 23f of the wire barrel part 23, a forth end surface covered part 43d provided on the end surfaces 24c, 24c of the second transition part 24, a fifth end surface covered part 43e provided on the end surfaces 25c, 25c, 25e, 25e, 25f, 25f, 25g of the insulation barrel part 25, and a sixth end surface covered part 43f provided on the end surfaces 21p, 21p, 21q of the contact lug 21b.

For the wire barrel part 23 and the insulation barrel part 25, chamfered parts 23d, 25d are applied to the end surfaces 23e, 25e that configure a part of the terminal 11C. The resin cover is applied to the chamfered parts 23d, 25d respectively to provide a first chamfered covered part 44a and a second resin chamfered covered part 44b. The first chamfered covered part 44a and the second chamfered covered part 44b configure the chamfered resin covered part 44. The chamfered resin covered part 44 configures a part of the resin covered part 40 (see FIG. 1(B)).

After forming the above-described resin covered part 40, the chain terminal 61 is cut off at line G-G and each terminal material 11E is separated from the frame part 62. After this separation, the resin covered part 40 is formed also on the end surface 25g, a blanked surface, as well by using the pulse spray method. Then, the box part 21, the first transition part 22, the wire barrel part 23, the second transition part 24, the insulation part 25 etc. are formed by bending to provide the terminal 11 (see FIG. 1(B)).

Referring to FIG. 3(A) and FIG. 3(B), with the above-described pulse spray method, the resin is applied to the chain terminal 61 by moving, for example, from above to below in the figures. At this time, it is difficult to intermittently apply the resin in a movement direction. In the present embodiment, the non-covered parts 46, 48 provided on two different sections continue in the movement direction of the chain terminal 61, thereby it is easy to apply the resin.

In the above embodiment, a metal member is separated from the frame part 62 at the line HH (see FIG. 2) in a process of blanking by a press machine etc. to form the chain terminal 61, then the resin is applied by using the pulse spray method to form the resin covered part 40; however, this is not limited thereto. A metal member may be separated from the frame part 62 at the line H-H and the line G-G in a process of blanking by a press machine etc. to make the metal member in a disassembled state by each terminal material 11E, then the resin may be applied by using the pulse spray method to both surfaces by spraying each surface separately to form the resin covered part 40.

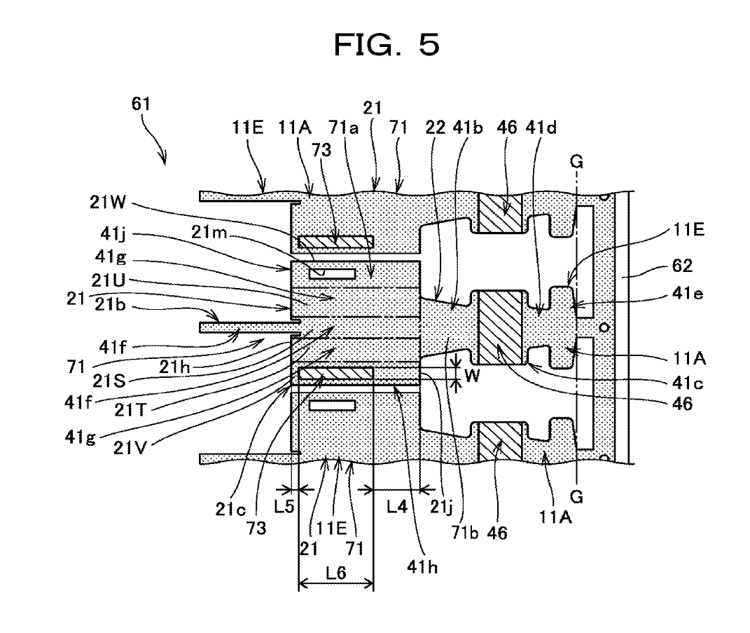

It is noted that when forming the above-described non-covered parts 46, 48, 73 (see FIG. 5), a predetermined masking may be performed if necessary, but it is possible to perform masking at an arbitrary timing before pulse spraying.

### Second Embodiment

FIG. 5 is a plan view showing an inner side resin covered part 71 of the second embodiment.

As for the same configuration with the first embodiment shown in FIG. 3 and FIG. 4, the same reference numeral is applied and the detailed description will not be repeated.

An inner resin covered part 71 is provided on the inner surface 11A of the terminal material 11E of the chain terminal 61 that is blanked from a metal material. The outer side resin covered part 42 (see FIG. 3(B)) and the end surface resin covered part 43 (see FIG. 4) are provided on the outer surface 11B (see FIG. 3(B)) and the end surface 11C (see FIG. 4) of the terminal material 11E.

A first inner surface covered part 71a of the inner side resin covered part 71 differs from the first inner surface covered part 41a of the inner side resin covered part 41 (see FIG. 3(A)) of the first embodiment. A resin material and a forming manner such as forming procedures of the inner side resin covered part 71 are the same as the inner side resin covered part 41 of the first embodiment.

In FIGS. 1(A) to 1(C) and FIG. 5, the box part 21 is configured of: a base part 21S to be a root part of the contact lug 21b; a pair of side parts 21T, 21U raised from both edges of the base part 21S; an inner ceiling part 21V bent from the side part 21T; and an outer ceiling part 21W which is bent such that the outer ceiling part 21W overlaps from the side part 21U to the outside of the inner ceiling part 21V.

The first inner surface covered part 71a is configured of: a base part inner surface covered part 41f provided on the base part 21S; side part inner surface covered parts 41g, 41g provided on the side parts 21T, 21U; an inner side ceiling covered part 41h provided on the inner side ceiling part 21V; and an outer side ceiling covered part 41j provided on the outer side ceiling part 21W.

The inner side ceiling covered part 41h is formed only within a range of a distance L4 from one end surface 21j of the box part 21 and a distance L5 from the other end surface 21h of the box part 21, and not formed within a longitudinal width L6 and width W of the terminal material 11E. A part of the inner surface 21c of the box part 21 on which the resin cover is not provided is a non-covered part 73 contacting a male terminal.

The length L6 and the width W of the non-covered part 46 is equal to or shorter than the length and the width of a contact part that is provided on the male terminal to be contacted to the inner side ceiling part 21V.

A shape of a male terminal inserted into the box part 21 is, as shown in FIG. 6 described later, a flat-plate shape, therefore, this male terminal contacts the non-covered part 48 of the contact projecting part 21a (See FIG. 3(B)) of the contact lug 21b and the non-covered part 73, then being sandwiched to secure electrical conduction.

In the present embodiment, the base part inner surface covered part 41f, the side part inner surface covered parts 41g, 41g, the inner side ceiling covered part 41h, and the outer side ceiling covered part 41j are provided on the inner surface 21c of the box part 21, and thus, it is possible to increase an area of the resin covered part as large as possible. Therefore, corrosion current between the core wire 14 of the covered electrical wire 12 and the terminal 11 shown in FIG. 1(C) can be made further hard to occur, and it is possible to restrain the corrosion of the core wire 14.

As shown in the above FIGS. 1(A) to 1(C), FIGS. 3(A) and 3(B), and FIG. 4, the terminal 11 has the box part 21 as a connection part connected to another terminal (male terminal) as well as the wire barrel part 23 and the insulation barrel part 25 as a crimping part crimp-connected to the covered electrical wire 12, wherein substantially all of a non-contact part, including the cut end surface 11C as a cut end surface upon blanking a metal member, is covered with the resin covered part 40, where the non-contact part is other than the contact part with the male terminal (non-covered part 48) and the contact part with the end part 14a that is an exposed part of the core wire 14 as a conductor of the covered electrical wire 12 (non-covered part 46).

According to this configuration, all of the non-contact part of the terminal 11, including the end surface 11C upon blanking, is covered with the resin covered part 40, where the non-contact part is other than the non-covered part 46 as a contact part with the end part 14a of the core wire 14 of the covered electrical wire 12 as well as the non-covered part 48 and/or a non-covered part 73 (see FIG. 5) as a contact part with an external terminal, and thus, corrosion current hardly flows between the core wire 14 of the covered electrical wire 12 and the terminal 11 even though water adheres to a surface of the core wire 14 of the covered electrical wire 12 and the terminal 11 when crimping the core wire 14 of the covered electrical wire 12 to the wire barrel part 23. Therefore, even when the core wire 14 and the terminal 11 are made of different metals, for example, the core wire 14 is made of aluminum or an aluminum alloy and the terminal 11 is made of copper or a copper alloy, it is possible to excellently restrain the corrosion of the core wire 14 and further ensure the conductive function between the core wire 14 of the covered electrical wire 12 and the terminal 11 over a long period.

In the present embodiment, all of the non-contact part of the terminal 11, including the end surface 11C, is covered with the resin covered part 40, therefore when the terminal 11 is made of copper or a copper alloy and the core wire 14 is made of an aluminum alloy, for example, the aluminum alloy remaining ratio in the core wire after a corrosion test of the connection structural body 10 (see FIG. 1(C)) was 80% or more, regardless of electrical wire size, etc. Further, when the corrosion test was conducted without providing the resin covered part on the end surface 11C, even though most of the part except the contact part and the end surface was applied to the resin cover and the corrosion test was performed under the same condition, the aluminum alloy remaining ratio fell below 70%. It is noted that the above-mentioned aluminum alloy remaining ratio refers to an exposed part of the core wire 14, and in FIG. 1(C), when being cut off along line F-F at a vicinity of a section crimped by the wire barrel lugs 32, 32, it is represented as: aluminum alloy remaining ratio=(cross-section area of the remaining core wire 14)/(cross-section area of the core wire 14 before corrosion).

Particularly, a terminal described in the Japanese Application Publication No. 2010-257719 was evaluated; however, it was revealed that it was not possible to obtain a desired anticorrosion property when adjusting only a ratio of an exposed area of a conductor of an electrical wire to an area of a non-resin covered section of a metal member. In the present application, high aluminum alloy remaining ratio and an excellent anticorrosion property is shown, since all, including the end surface 11C, are covered with the resin covered part 40.

Further, as shown in FIGS. 1(B) and 1(C), the crimping part is configured by the wire barrel part 23 and the insulation barrel part 25, and thus, when securing the non-covered part 46 which is a contact site with the end part 14a of the core wire 14 of the covered electrical wire 12 at the wire barrel part 23 and providing the second inner surface covered part 41b at the insulation barrel part 25, it is possible to increase the area of the resin covered part 40 of the terminal 11 while securing electrical conduction between the terminal 11 and the core wire 14 of the covered electrical wire 12.

Further, as shown in FIGS. 4(A), 4(B), and FIG. 5, the resin covered part 40 is formed by using the pulse spray method and fluid is sprayed so as to provide shearing force, therefore problems such as fluid clogging or liquid balling are decreased.

As a result, it is possible to turn resin fluid into a suitable mist state and thereby it is possible to apply the resin fluid to an object having a complicated shape. That is, it is possible to easily and uniformly cover even a cut end surface (end surface 11C) upon blanking of a terminal 11, with resin.

Further, as shown in FIG. 1(C), the connection structural body 10 connects the core wire 14 of the covered electrical wire 12 to the wire barrel part 23 on the terminal 11, and thus, corrosion current hardly flows between the core wire 14 of the covered electrical wire 12 and the terminal 11 even though water adheres to surfaces of the core wire 14 of the covered electrical wire 12 and the terminal 11. Therefore, it is possible to restrain a galvanic corrosion and to ensure a conductive function between the core wire 14 of the covered electrical wire 12 and the terminal 11 over a long period.

### Second Embodiment

FIG. 6 is a perspective view showing the male terminal 81 of the second embodiment of the present invention.

The male terminal (terminal) 81 has a box part 83, a plate-shaped tab 84 protruding from one end of the box part 83, a tube-shaped swaging part 85, and a transition part 86 serving as a bridge for the box part 83 and the tube-shaped swaging part 85, and a base material is made of copper or a copper alloy.

The box part 83 is a portion that regulates an insertion position when the tab 84 is inserted into the box part 21 (see FIG. 1) of the male-type terminal 11 (see FIG. 1) as well as a portion that is gripped by fingers.

The tab 84 has a rectangular flat plate part 84a and a pointed taper part 84b formed at a tip part of the flat plate part 84a.

The contact projecting part 21a (see FIG. 1(A)) of the terminal contacts a first contact surface 84c that is one side of the flat plate part 84a, and the lower projecting part 21n (see FIG. 1(A)) of the box part 21 contacts a second contact surface 84d that is a back surface of the first contact surface 84c. The taper part 84b is provided to smoothly perform an insertion into the terminal 11.

The tube-shaped swaging part 85 is a site in which an electrical wire is crimped and joined, and consists of a diameter-increasing part 91 which gradually increases in diameter from the transition part 86, and a cylindrical part 92 extending in a cylindrical shape from the edge part of the diameter-increasing part 91 while keeping the diameter to the same value.

At one end of the cylindrical part 92, an electrical wire insertion port 94 in which an electrical wire to be inserted opens up. The transition part 86 side of the diameter-increasing part 91 is crushed then welded to form a weld bead part 95, and infiltration of water or the like from the transition part 86 side is prevented by the weld bead part 95. A weld bead part 96 extending in an axis direction is formed on the tube-shaped swaging part 85.

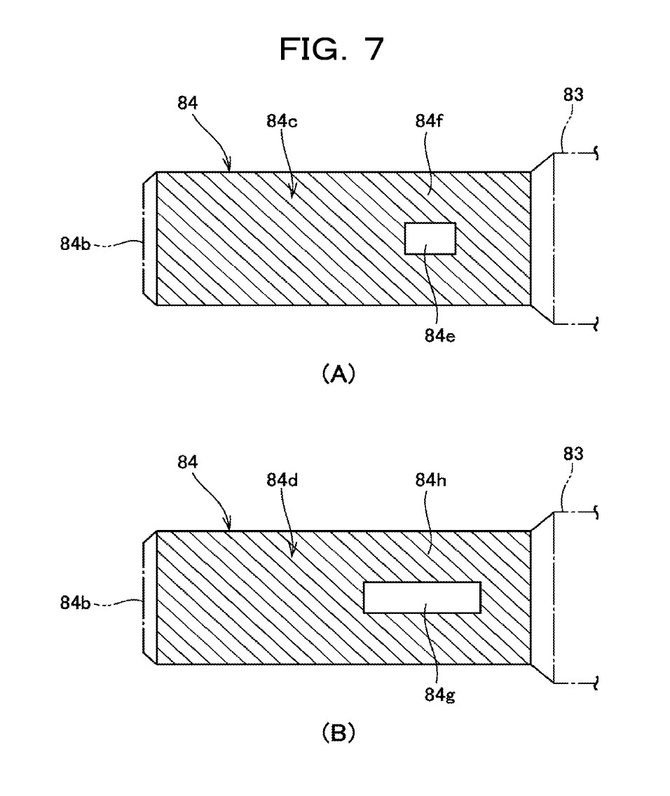

FIG. 7 is a schematic diagram showing a contact surface with a terminal 11 of a tab 84. FIG. 7(A) is a diagram showing a first contact surface 84c of the tab 84, and FIG. 7(B) is a diagram showing a second contact surface 84d of the tab 84.

As shown in FIG. 7(A), on the first contact surface 84c, a rectangle contact part 84e with which the contact projecting part 21a (see FIG. 1(A)) comes into contact is provided at a part closer to the box part 83 in the longitudinal direction and the center in the widthwise direction (vertical direction in the figure). Further, a portion other than the contact part 84e of the first contact surface 84c is a non-contact part 84f (hatched portion) and a resin cover is formed on the non-contact part 84f.

As shown in FIG. 7(B), on the second contact surface 84d, a rectangle contact part 84g with which the lower projecting part 21n (see FIG. 1(A)) of the connection terminal 11 (see FIG. 1) comes into contact is provided. Further, a portion other than the contact part 84g of the second contact surface 84d is a non-contact part 84h (hatched portion) and a resin cover is formed on the non-contact part 84h.

For the male terminal 81 as shown in the FIG. 6 and FIG. 7, substantially all of the surfaces of the non-contact parts 84f, 84h not contacting a core wire of an electrical wire and the terminal 11 at all, including a cut end surface upon blanking a metal member, is covered with insulation resin. Therefore, similarly to the terminal 11 (see FIG. 1) of the first embodiment that is explained above, it is possible to excellently restrain a galvanic corrosion.

The above-described embodiments merely shows an aspect of the present invention, and can be optionally modified and applied without departing from the gist of the present invention. Particularly, a female terminal is used to explain the present invention; however, the present invention is also applicable to a male terminal.

Further, for example, in the above-mentioned embodiment, acrylate resin and a polyamideimide are used as the material of the insulating cover provided on the terminal 11; however, this is not limited thereto, and acrylic resin, acrylonitrile-styrene resin, acrylonitrile-butadiene-styrene resin, polyurethane resin, melamine resin, epoxy resin, phenol resin, polyethylene resin, polypropylene resin, vinyl chloride resin, polystyrene resin, polyethylene terephthalate resin, vinylidene chloride resin, or fluorocarbon resin may be used.

Further, copper or a copper alloy is used as the material of the terminal 11, and aluminum or an aluminum alloy is used as the material of the core wire 14 of the covered electrical wire 12; however, this is not limited thereto.

Further, the shape of the terminal 11 is not limited to the shape described in the present embodiment.

### REFERENCE SIGNS LIST

10 connection structural body
11 terminal
11C end surface (cut end surface)
12 covered electrical wire
14 core wire (conductor)
14a end part (exposed part)
21 box part (connection part)
23 wire barrel part (crimping part)
25 insulation barrel part (crimping part)
40 resin covered part
46 non-covered part (contact part with exposed part of conductor)
48, 73 non-covered part (contact part with another terminal)
81 terminal (male terminal)

1. A terminal including a connection part connected to another terminal and a crimping part crimp-connected to a covered electrical wire, wherein substantially all of a non-contact part, including a cut end surface upon blanking a metal member, is covered with a resin covered part, where the non-contact part is other than a contact part with the other terminal and a contact part with an exposed part of a conductor of the covered electrical wire.

2. The terminal according to claim 1, wherein the crimping part is comprised of a wire barrel part and an insulation barrel part.

3. The terminal according to claim 1, wherein the resin covered part is formed by using a pulse spray method.

4. The terminal according to claim 1, wherein the resin covered part is formed to cover equal to or more than 95% of a terminal surface.

5. A connection structural body, comprising: the covered electrical wire connected to the crimping part of the terminal according to claim 1.

6. A method of manufacturing a terminal including a connection part connected to another terminal and a crimping part crimp-connected to a covered electrical wire, wherein substantially all of a non-contact part, including a cut end surface upon blanking a metal member, is covered with resin, where the non-contact part is other than a contact part with the other terminal and a contact part with an exposed part of a conductor of the covered electrical wire.

7. The method of manufacturing a terminal according to claim 6, wherein the step of being covered with resin is coating resin fluid by spraying at a constant interval.

8. The method of manufacturing a terminal according to claim 6, wherein the step of being covered with resin is performed while the contact part is being masked prior to being covered with resin.
